(19) United States
(12) Patent Application Publication
(10) Pub. No.: US 2005/0085407 A1
(43) Pub. Date: Apr. 21, 2005

(54) Dust control composition

(75) Inventors: Louis Oldenhove, Liege (BE); Marianne Mahieu, Ayeneux (BE)

Correspondence Address: Colgate-Palmolive Company, 909 River Road, P.O. Box 1343, Piscataway, NJ, 08855-1343, US

(73) Assignee: Colgate-Palmolive Company

(21) Appl. No.: 10/688,634

(22) Filed: Oct. 17, 2003

(51) Int. Cl. C11D 1/00

(52) U.S. Cl. 510/504

(57) ABSTRACT

The present invention relates to a liquid dust control composition comprising an anionic surfactant, a dust control agent and water.

### FIELD OF THE INVENTION

This present invention relates to a dust control composition which is applied to a surface thereby preventing the deposit of dust on the surface.

### BACKGROUND OF THE INVENTION

A major problem is the prevention of the deposition of dust on substrates such as glass, wood or plastic. Dust particles from the air are constantly depositing on surfaces and are an ideal place for dust mites to reside in. The present invention relates to a liquid composition which can be coated onto a substrate thereby preventing the depositing of the dust on the substrate.

Some patents disclose dust control compositions aiming at decreasing the dust level present in the air by avoiding the dust emission from specific dust sources; in this frame, we can mention: a method of suppressing dust at an ore handling point comprising wetting the ore and the dust with an aqueous composition is disclosed in U.S. Pat. No. 6,432,166; a dust control composition for fertilizer for the purpose of reducing the dust levels present in the fertilizer is disclosed in U.S. Pat. No. 6,355,083; a treatment product for earth surfaces, particularly earth surfaces which generate dust such as dirt roads or parking lots is disclosed in U.S. Pat. No. 6,443,661; compositions having an increased propensity to reduce dust generation from granular materials during processing of such materials are disclosed in U.S. Pat. No. 5,484,477.

U.S. Pat. No. 4,075,375 discloses oil-impregnated fibrous articles represented by mops and used for cleaning floors and the like and also used for removing dust deposited on walls, furniture, book cases and the like. Patent WO02/24859 discloses wipes premoistened with an antistatic amphoteric cleaning composition.

The compositions considered in the present study are based on a different mechanism than anti-static properties; they have the ability to produce on treated surfaces a coating delivering long-lasting prevention delaying dust apparition on said surfaces via a reduction of the friction between the dust and the surface. U.S. Pat. No. 6,132,638 titled “Dust Control Composition” teaches numerous instant compositions of this invention.

### SUMMARY OF THE INVENTION

The instant invention teaches that it is possible to deliver a dust preventive treatment impeding the attachment and/or adhesion of dust on the treated surfaces by applying on the target surfaces the anti-dust adhesion compositions of this invention. The treatments can be applied with spray or impregnated wipes.

The present invention relates to a liquid dust control composition which is coated on a substrate in order to minimize the depositing of the dust on a substrate. The liquid dust control composition comprises at least one anionic surfactant, a dust control agent and water.

### DETAILED DESCRIPTION OF THE INVENTION

The present invention relates to a liquid dust control composition comprising approximately by weight:

(a) 0.025% to 5.0%, more preferably 0.5% to 2.5% of at least one anionic surfactant;

(b) 0.025% to4.0%, more preferably 0.05% to 1.0% of a dust control agent which is selected from the group consisting of choline chloride and quaternized alkylolamine methosulfate having about 2 to about 18 carbon atoms;

(c) 0 to 5%, more preferably 0.25% to 4% of a C₂-C₄ alkanol such as ethanol or isopropanol;

(d) 0 to 6%, more preferably 0.25% to 2.5% of at least one water soluble cosurfactant; and

(e) the balance being water, wherein the composition does not contain a compound selected from the group consisting of polyvinyl pyrrolidone having a molecular weight of about 10,000 to 1,000,000, N-octyl-2-pyrrolidone (Surfadone LP100), N-dodecyl-2-pyrrolidone (Surfadone LP300), polysiloxane polyorgano betaine copolymer (Abil 9950), a diquaternary polydimethyl siloxane (Abil Quat 3272), (a water soluble polymer to which is anchored perfluoralkyl units), a copolymer of polyvinyl pyrrolidone/polyvinyl-imidazole copolymer (CPHS75-BASF Corp.), a polyvinyl pyrrolidone/polyacrylate copolymer (Gaftex 1033), an alkoxy silane-quaternary compound (DC5700-Dow Corning), cyclotetra dimethyl siloxane (DC344-Dow Corning), cyclopenta dimethyl siloxane (DC345-Dow Corning), diethyl cyclohexyl amine salt of lauryl sulfate (Duponol G-Dupont), anionic R_{f}CH₂CH₂SO₃X, wherein X=H or NH4 (Zonyl TBS-Dupont), nonionic R_{f}CH₂CH₂O(CH₂CH₂O) wherein R_{f} is F—(CF₂-CF₂)_{y}, wherein y is 3 to 8, wherein x=1 to 50 (Zonyl FSN-Dupont), amphoteric R_{f}CH₂CH(OCOCH₃)CH₂N⁺(CH₃)₂CH₂CO₂⁻)Zonyl FSK-Dupont) wherein R_{f} is F—(CF₂-CF₂)_{y}, wherein y is 3 to 8, (R_{f}CH₂CH₂O)P(O)(ONH₄)₂X plus nonfluorinated surfactant (Zonyl FSJ-Dupont), Hycryl 964 polyacrylate polymer containing Ubatol U-3910.

Suitable water-soluble non-soap, anionic surfactants include those surface-active or detergent compounds which contain an organic hydrophobic group containing generally 8 to 26 carbon atoms and preferably 10 to 18 carbon atoms in their molecular structure and at least one water-solubilizing group selected from the group of sulfonate, sulfate and carboxylate so as to form a water-soluble detergent. Usually, the hydrophobic group will include or comprise a C₈-C₂₂ alkyl, alkyl or acyl group. Such surfactants are employed in the form of water-soluble salts and the salt-forming cation usually is selected from the group consisting of sodium, potassium, or magnesium, with the sodium and magnesium cations again being preferred.

Examples of suitable sulfonated anionic surfactants are the well known higher alkyl mononuclear aromatic sulfonates such as the higher alkyl benzene sulfonates containing from 10 to 16 carbon atoms in the higher alkyl group in a straight or branched chain, C₈-C₁₅ alkyl toluene sulfonates and C₈-C₁₅ alkyl phenol sulfonates.

A preferred sulfonate is linear alkyl benzene sulfonate having a high content of 3− (or higher) phenyl isomers and a correspondingly low content (well below 50%) of 2− (or lower) phenyl isomers, that is, wherein the benzene ring is preferably attached in large part at the 3 or higher (for example, 4, 5, 6 or 7) position of the alkyl group and the content of the isomers in which the benzene ring is attached in the 2 or 1 position is correspondingly low. Particularly preferred materials are set forth in U.S. Pat. No. 3,320,174.

Other suitable anionic surfactants are the olefin sulfonates, including long-chain alkene sulfonates, long-chain hydroxyalkane sulfonates or mixtures of alkene sulfonates and hydroxyalkane sulfonates. These olefin sulfonate detergents may be prepared in a known manner by the reaction of sulfur trioxide (SO₃) with long-chain olefins containing 8 to 25, preferably 12 to 21 carbon atoms and having the formula RCH═CHR₁ where R is a higher alkyl group of 6 to 23 carbons and R₁ is an alkyl group of 1 to 17 carbons or hydrogen to form a mixture of sultones and alkene sulfonic acids which is then treated to convert the sultones to sulfonates. Preferred olefin sulfonates contain from 14 to 16 carbon atoms in the R alkyl group and are obtained by sulfonating an a-olefin.

Other examples of suitable anionic sulfonate surfactants are the paraffin sulfonates containing 10 to 20, preferably 13 to 17, carbon atoms. Primary paraffin sulfonates are made by reacting long-chain alpha olefins and bisulfites and paraffin sulfonates having the sulfonate group distributed along the paraffin chain are shown in U.S. Pat. Nos. 2,503,280; 2,507,088; 3,260,744; 3,372,188; and German Patent 735,096.

Examples of satisfactory anionic sulfate surfactants are the C₈-C₁₈ alkyl sulfate salts and the C₈-C₁₈ alkyl sulfate salts and the ethoxylated C₈-C₁₈ alkyl ether sulfate salts having the formula R(OC₂H₄)ₙ OSO₃M wherein n is 1 to 12, preferably 1 to 5, and M is a metal cation selected from the group consisting of sodium, potassium, ammonium, magnesium and mono-, di- and triethanol ammonium ions. The alkyl sulfates may be obtained by sulfating the alcohols obtained by reducing glycerides of coconut oil or tallow or mixtures thereof and neutralizing the resultant product.

On the other hand, the ethoxylated alkyl ether sulfates are obtained by sulfating the condensation product of ethylene oxide with a C₈-C₁₈ alkanol and neutralizing the resultant product. The alkyl sulfates may be obtained by sulfating the alcohols obtained by reducing glycerides of coconut oil or tallow or mixtures thereof and neutralizing the resultant product. On the other hand, the ethoxylated alkyl ether sulfates are obtained by sulfating the condensation product of ethylene oxide with a C₈-C₁₈ alkanol and neutralizing the resultant product. The ethoxylated alkyl ether sulfates differ from one another in the number of moles of ethylene oxide reacted with one mole of alkanol. Preferred alkyl sulfates and preferred ethoxylated alkyl ether sulfates contain 10 to 16 carbon atoms in the alkyl group.

The ethoxylated C₈-C₁₂ alkylphenyl ether sulfates containing from 2 to 6 moles of ethylene oxide in the molecule also are suitable for use in the inventive compositions. These surfactants can be prepared by reacting an alkyl phenol with 2 to 6 moles of ethylene oxide and sulfating and neutralizing the resultant ethoxylated alkylphenol.

Other suitable anionic surfactants are the ethoxylated C₉-C₁₅ alkyl ether carboxylates having the structural formula R(OC₂H₄)ₙOX COOH wherein n is a number from 4 to 12, preferably 5 to 10 and X is selected from the group consisting of 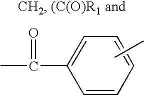
wherein R₁ is a C₁-C₃ alkylene group. Preferred compounds include C₉-C₁₁ alkyl ether polyethenoxy (7-9) C(O) CH₂CH₂COOH, C₁₃-C₁₅ alkyl ether polyethenoxy (7-9) 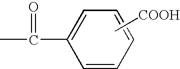
and C₁₀-C₁₂ alkyl ether polyethenoxy (5-7) CH2COOH. These compounds may be prepared by considering ethylene oxide with appropriate alkanol and reacting this reaction product with chloracetic acid to make the ether carboxylic acids as shown in U.S. Pat. No. 3,741,911 or with succinic anhydride or phthalic anhydride. Obviously, these anionic surfactants will be present either in acid form or salt form depending upon the pH of the final composition, with salt forming cation being the same as for the other anionic surfactants.

Of the foregoing non-soap anionic surfactants used in forming the instant compositions the preferred anionic surfactant is a sodium C₈-C₁₈ linear alkyl benzene sulfonate.

Highly suitable cosurfactants for the microemulsion over temperature ranges extending from 5° C. to 43° C. for instance are glycerol, ethylene glycol, water-soluble polyethylene glycols having a molecular weight of 300 to 1000, polypropylene glycol of the formula HO(CH₃CHCH₂O)ₙH wherein n is a number from 2 to 18, mixtures of polyethylene glycol and polypropyl glycol (Synalox) and mono C₁-C₆ alkyl ethers and esters of ethylene glycol and propylene glycol having the structural formulas R(X)ₙOH and R₁(X)ₙOH wherein R is C₁-C₆ alkyl group, R₁ is C₂-C₄ acyl group, X is (OCH₂CH₂) or (OCH₂(CH₃)CH) and n is a number from 1 to 4, diethylene glycol, triethylene glycol, an alkyl lactate, wherein the alkyl group has 1 to 6 carbon atoms, 1methoxy-2-propanol, 1methoxy-3-propanol, and 1methoxy 2-, 3- or 4-butanol. Preferred cosurfactants are propylene glycol n-butyl ether and dipropylene glycol n-butyl ether.

The following examples illustrate the liquid dust control compositions of the described invention. Unless otherwise specified, all percentages are by weight. The exemplified compositions are illustrative only and do not limit the scope of the invention.

### EXAMPLE 1

The following compositions were made by simple mixing at 25° C.:

| | A | B | C | D |
|---|---|---|---|---|
| | (wt. %) | (wt. %) | (wt. %) | (wt. %) |
| Sodium lauryl sulfate | 1 | 1 | 1 | 1 |
| Ethanol | 3 | 3 | 3 | 3 |
| Propylene glycol n-butyl ether | 1 | — | 1 | — |
| Dipropylene glycol n-butyl ether | — | 1 | — | 1 |
| Choline chloride | 0.05 | 0.05 | — | — |
| Stepantex DN alkylolamine | — | — | 0.05 | 0.05 |
| methosulfate | | | | |
| Fragrance | 0.05 | 0.05 | 0.05 | 0.05 |
| pH | 7.25 | 7.25 | 7.25 | 7.25 |
| (adjusted with hydrochloric acid) | | | | |

Prevention of Dust Anchoring

Test Methodology:

Melaminated wood panes are used as model surface (15×20 cm²). 0.5 g of the product to test is applied on a half tile by wiping with a paper towel for about 15 strokes. The tile is let at rest 10 minutes for complete drying, and dusted with dust from a vacuum cleaner bag that is sifted and sprinkled above the sloped tile. If the treatment is effective, the dust does not remain on the treated part of the wood pane. 5 replicates are realized for each type of treatment. All the panes are submitted to a visual assessment. The score is given for the treated part, considering that the untreated part is the reference with a 0 score. The higher the score, the better the prevention of the dust anchoring. A score of 10 corresponds to a surface that is absolutely clean and free from dust.

Performance Ratings:

| | Score |
|---|---|
| Untreated tile = reference | 0 |
| Water | 0 |
| Treatment with-a commercial anti-static | 0 |
| window cleaner | |
| Treatment with A | 5.4 |
| Treatment with B | 4.8 |
| Treatment with C | 6.3 |
| Treatment with D | 5.6 |

The four prototypes (A, B, C & D) provide a good dust prevention effect (score 4.8-6.3) which corresponds to a reduction of the dust anchoring to the surface. That is not observable with a regular anti-static product.

Test Methodology to Evaluate the Antistatic Effect:

Perspex tiles are used as model surface. In a first step, the tile is treated with the product to evaluate (2 g of product applied with a paper towel with the help of a mechanical automatic system) and let dried.

Using the same robot, static electricity is generated on the plastic tile by friction with a dry paper towel, before contact with dust coming directly from a vacuum cleaner bag. The dust is finally removed, again with the same mechanical system equipped with dry paper towel. If the antistatic treatment is effective, the dust is easily removed from the tile; if it is not, the dust remains attracted by the plastic tile and is not removed. 5 replicates are realized for each type of treatment. All the tiles are submitted to a visual assessment. The higher the score, the better the anti-static effect. Score 0 corresponds to a very dirty tile, with no dust removal. Score 10 corresponds to a surface that is absolutely clean and free from Dust.

| | Score |
|---|---|
| Untreated tile = reference | 0 |
| Water | 2.0 |
| Treatment with-a commercial anti-static | 6.8 |
| window cleaner | |
| Treatment with A | Not determined |
| Treatment with B | 5.2 |
| Treatment with C | Not determined |
| Treatment with D | 5.6 |

Whereas slightly less performing than a regular anti-static product,-prototypes of the present invention deliver a very good dust protection even in the case static electricity is generated onto the surface. This anti-static property is attributed to the presence of choline chloride or Stepantex DN that are known anti-static agents.

1. A liquid dust control composition comprising approximately by weight:
(a) 0.1% to 5.0% of at least one anionic surfactant;
(b) 0.025% to 1.0% of a dust control agent, which is selected from the group consisting of alkylol methosulfate and choline chloride; and
(c) the balance being water.

2. The composition according to claim 1 wherein said anionic surfactant is a sulfate surfactant.

3. The composition according to claim 2 further including a C₂-C₄ alkanol.

4. The composition according to claim 3 further including a water soluble glycol ether cosurfactant.
